(19) United States
(12) Patent Application Publication
(10) Pub. No.: US 2008/0033619 A1
(43) Pub. Date: Feb. 7, 2008

(54) Vehicle controller and method of controlling a vehicle

(75) Inventors: Takaaki Tokura, Nagoya-shi (JP); Toshio Sugimura, Nagoya-shi (JP); Tomohiro Asami, Nisshin-shi (JP); Nobufusa Kobayashi, Anjo-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA

(21) Appl. No.: 11/826,408

(22) Filed: Jul. 16, 2007

(30) Foreign Application Priority Data
Aug. 1, 2006 (JP) 2006-209829

(51) Int. Cl. F02D 29/02; B60W 10/06; B60W 50/06

(52) U.S. Cl. 701/54; 701/84

(57) ABSTRACT

When it is determined that the torque output from a power source is being automatically controlled, an ECU prohibits torque-boosting control of the power source during the torque phase when up-shifting, and performs up-shifting without performing torque-boosting control. In performing torque-boosting control, the driver demanded torque in response to the accelerator operation amount is used as the reference in setting amount of torque demanded from the power source.

### INCORPORATION BY REFERENCE

The disclosure of Japanese Patent Application No. 2006-209829 filed on Aug. 1, 2006, including the specification, drawings and abstract, is incorporated herein by reference in its entirety.

### BACKGROUND OF THE INVENTION

1. Field of the Invention

The present invention relates to a vehicle controller and a method of controlling a vehicle. Specifically, the present invention boosts the torque of a power source during the torque phase when an automatic transmission up-shifts.

2. Description of the Related Art

It is known that, when up-shifting an automatic transmission, in the torque phase the drive power is reduced, after which, when transitioning from the torque phase to a inertia phase, the drive power increases, generating a torque shock. In order to suppress the shock when a gear shift is performed, one approach is to boost the torque during the torque phase.

Japanese Patent Application Publication No. JP-A-2004-316838 describes a transmission gear shift-controller that boosts the torque of the power source to proceed with an intended gear shift. The transmission shift controller includes a power source torque upper limit calculator that determines the upper torque limit that can be generated by the power source during a gear shift at the time of a gear shift command, a power source torque boost calculator that determines the torque generation demanded of the power source when the torque is boosted at the time of a gear shift command, a target engaging force setting section that sets the target engaging force of the gear shift friction element for changing gears based on the power source torque upper limit when it is determined that the boosted power source torque exceeds the power source torque upper limit, a power source torque control section that controls the power source so that the output torque is the torque upper limit if the power source torque exceeds the power source torque upper limit when the torque is boosted during a gear shift, and a friction element engaging control section that controls the friction element so that the engaging force thereof is made the target engaging force if the power source torque exceeds the power source torque upper limit when the torque is boosted.

According to the transmission gear shift controller described in JP-A-2004-316838, when compensating for an insufficiency in torque boost because of the power source torque upper limit by correction of the engaging force of the friction engaging element for gear shifting, a feed-forward control is used to perform the correction. For this reason, even if the engaging force of the friction element is being corrected, the problem related to low response in the case of feedback control is eliminated, and it is possible to reduce the output torque step immediately after the torque phase during a gear shift.

By boosting torque during the torque phase, if torque is boosted based on a torque demanded in response to the demanded output amount demanded by the driver (for example, by an accelerator operation amount), there is a problem of a discontinuity in drive power because of the torque boosting. For example, if an up-shift is requested when the power source is being automatically controlled, regardless of the amount of output demanded by the driver, when torque is boosted during the torque phase, the torque boost is performed based on the torque demanded by the driver. As a result, the ultimately controlled torque of the power source becomes discontinuous, resulting in a sudden change in the drive power.

### SUMMARY OF THE INVENTION

The present invention provides a controller for a vehicle suppresses torque shock when shifting gears.

A first aspect of the present invention relates to a vehicle controller. The vehicle, in which the controller is installed, is generally equipped with a power source and an automatic transmission, connected to the power source, that establishes a plurality of gear steps with different gear ratios by selectively engaging a plurality of friction engaging elements. When up-shifting the automatic transmission, the torque of the power source is boosted during the torque phase. The controller also has a prohibiting device that prohibits increases in torque when the torque of the power source is automatically controlled independently of the demanded output amount.

According to the vehicle controller the first aspect, when the torque of the power source is automatically controlled independently of the demanded output amount demanded by the driver (for example, the accelerator operation amount), torque boosting is prohibited during the torque phase. By doing this, it is possible to suppress sudden changes in the torque output from the power source from the automatically controlled torque to the torque referenced to the demanded torque. For this reason, it is possible to suppress a sudden change of the drive power. As a result, it is possible to provide a controller of a vehicle that suppresses the generation of a torque shock when the gear shifting.

The vehicle controller according to the first aspect of the present invention may further include an output controller that controls the power source in order to increase the torque based on a torque responsive to the demanded output amount when increasing the torque during the torque phase.

By doing this, when performing an up-shift of the automatic transmission, in boosting the torque of the power source during the torque phase, it is possible to control the power source to boost the torque using the demanded torque responsive to an amount demanded by a driver (for example, an accelerator operation amount) as a reference.

The demanded output amount may be a value corresponding to an accelerator operation amount.

The automatic control of the torque of the power source may be performed when a shift lever is operated from a position not intended for moving a vehicle to a position intended for moving a vehicle.

The torque of the power source may be automatically controlled when wheel slip is detected when starting and/or accelerating.

The torque of the power source may automatically controlled when a slide-slipping of vehicle is detected.

A second aspect of the present invention relates to a method of controlling a vehicle. The method controls a vehicle equipped with a power source and an automatic transmission, connected to the power source, that establishes a plurality of gear steps with different gear ratios by selectively engaging a plurality of friction engaging elements. The vehicle is controlled by increasing the torque of the power source during a torque phase of the up-shift when the automatic transmission is up-shifted, and prohibiting an increase of the torque during the torque phase when the torque output of the power source is automatically controlled, independently of the output amount demanded by a driver.

### BRIEF DESCRIPTION OF THE DRAWINGS

The foregoing and further objects, features, and advantages of the invention will become apparent from the following description of preferred embodiments with reference to the accompanying drawing, wherein like numerals are used to represent like elements, and wherein:

FIG. 1 shows a simplified view of the configuration of a vehicle powertrain;

FIG. 2 is a skeleton diagram showing the planetary gear unit of an automatic transmission;

FIG. 3 is a drawing showing the operation table of an automatic transmission;

FIG. 4 is a drawing showing the hydraulic circuit of an automatic transmission;

FIG. 5 is a functional block diagram of an ECU;

FIG. 6 is a drawing showing the control structure of a program executed by an ECU;.

FIG. 7 is a timing diagram showing the change in the demanded torque amount;

FIG. 8 is a timing diagram showing the change in the drive power; and

FIG. 9 is a drawing showing the relationship between the torque set by automatic control and the driver demanded torque.

### DETAILED DESCRIPTION OF THE PREFERRED EMBODIMENTS

Example embodiments of the present invention are described below with reference made to the accompanying drawings. In the description to follow, the same reference numerals and names are assigned to the same elements, and previously described elements are not repeatedly described.

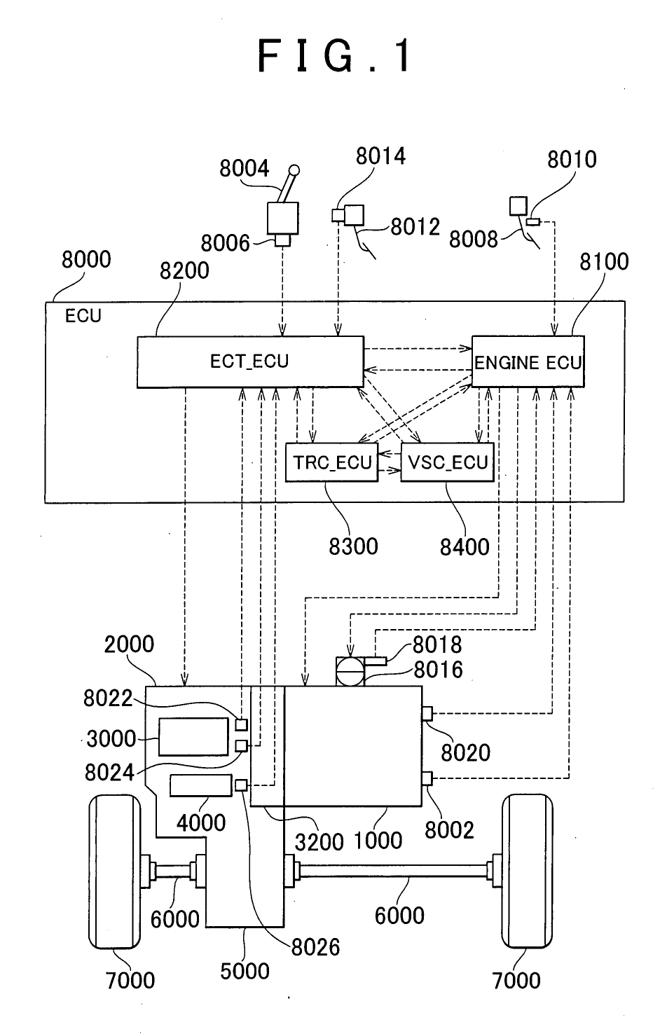

Referring to FIG. 1, a vehicle in which a controller according to an embodiment of the present invention will be described. This vehicle is a front-engine, front-drive (FF) vehicle, but may be a different type of vehicle.

The vehicle shown in FIG. 1 includes an engine 1000, an automatic transmission 2000, a planetary gear unit 3000 forming part of the automatic transmission 2000, a hydraulic circuit 4000 forming part of the automatic transmission 2000, a differential gear 5000, a drive shaft 6000, front wheels 7000, and an ECU 8000 (electronic control unit). The controller according to an embodiment of the present invention is implemented, for example, by executing a program stored in a ROM (read only memory) of the ECU 8000.

The engine 1000 is an internal combustion engine that combusts a gas mixture of fuel injected from an injector (not illustrated) and air in a cylinder. The fuel combustion pushes a piston within the cylinder downward, causing rotation of the crankshaft. An electric motor may be used as a power source in place of, or in addition to, the engine 1000.

The automatic transmission 2000 is coupled to the engine 1000 via a torque converter 3200. The automatic transmission 2000 changes the rotational speed of the crankshaft to a desired rotational speed by forming a desired gear steps.

The output gear of the automatic transmission 2000 meshes with the differential gear 5000. The drive shaft 6000 is coupled to the differential gear 5000 by means of a spline fit or the like. Power is transmitted to the left and right front wheels 7000 via the drive shaft 6000.

A water temperature sensor 8002, a position switch 8006 of the gear shift lever 8004, an accelerator operation amount sensor 8010 of the accelerator pedal 8008, a pedal force sensor 8014 of the brake pedal 8012, a throttle opening sensor 8018 of the electronic throttle valve 8016, an engine speed sensor 8020, an input shaft rotational speed sensor 8022, an output shaft rotational speed sensor 8024, and an oil temperature sensor 8026 are connected to the ECU 8000 via a wiring harness.

The temperature sensor 8002 detects the temperature of the coolant of the engine 1000 (hereinafter coolant temperature), and sends a signal indicating the detection result to the ECU 8000. The position of the gear shift lever 8004 is detected by the position switch 8006, which sends a signal indicating the detection result to the ECU 8000. The gear step of the automatic transmission 2000 is selected in response to the position of the gear shift lever 8004. A configuration may be adopted in which it is possible to select a manual shift mode in which the gear step may be selected by an operation by the driver.

The accelerator operation amount sensor 8010 detects the operation of the accelerator pedal 8008, and sends a signal indicating the detection result to the ECU 8000. The pedal force sensor 8014 detects the pedal force of the brake pedal 8012 (force with which the driver presses on the brake pedal 8012) and sends a signal indicating the detection result to the ECU 8000.

The throttle-opening sensor 8018 detects the opening amount of the electronic throttle valve 8016, which is adjusted by an actuator, and sends a signal indicating the detection result to the ECU 8000. The electronic throttle valve 8016 adjusts the amount of air taken into the engine 1000 (output of the engine 1000).

In place of, or in addition to, the electronic throttle valve 8016, the amount of lift or the opening/closing phase of an intake valve (not illustrated) or exhaust valve (not illustrated) may be changed to adjust the amount of air taken into the engine 1000.

The engine speed sensor 8020 detects the rotational speed of the output shaft (crankshaft) of the engine 1000, and sends a signal indicating the detected rotational speed to the ECU 8000. The input shaft rotational speed sensor 8022 detects the rotational speed NI of the input shaft (turbine rpm NT of the torque converter 3200) and sends a signal indicating the detection result to the ECU 8000. The output shaft rpm sensor 8024 detects the rotational speed of the output shaft NO of the automatic transmission 2000 and sends a signal indicating the detection result to the ECU 8000.

The oil temperature sensor 8026 detects the temperature (oil temperature) of oil (automatic transmission fluid: ATF) used in the operation or lubrication of the automatic transmission 2000, and sends a signal indicating the detection result to the ECU 8000.

The ECU 8000 controls mechanisms to achieve a desired running condition of the vehicle, based on the signals sent from the coolant temperature sensor 8002, the position switch 8006, the accelerator operation amount sensor 8010, the pedal force sensor 8014, the throttle opening sensor 8018, the engine speed sensor 8020, the input shaft speed sensor 8022, the output shaft speed sensor 8024, the oil temperature sensor 8026 and the like, and also based on a map and a program stored in ROM.

In this embodiment, if the gear shift lever 8004 is in the D (drive) position, causing selection of the D (drive) shift range of the automatic transmission 2000, the ECU 8000 controls the automatic transmission 2000 to select an appropriate gear step from any of the first gear step to the sixth gear step. By selecting one of the first to sixth gear steps, the automatic transmission 2000 can transmit drive power to the front wheels 7000. In the D range, there may be additional gears, such as a seventh gear or a eighth gear, that are higher-speed gears than the sixth gear step. An appropriate gear step is formed based on a pre-established gear shift diagram determined experimentally using vehicle speed and accelerator operation amount as parameters.

As shown in FIG. 1, the ECU 8000 includes an engine ECU 8100 that controls the engine 1000 and an electronic controlled transmission ECU, the ECT_ECU 8200, that controls the automatic transmission 2000.

The ECU 8000 also has a traction control ECU, the TRC_ECU 8300, that controls the output torque when the vehicle is starting and accelerating, and a vehicle stability control ECU, the VSC_ECU 8400, which automatically controls the output torque of the engine 1000 to suppress skidding of the vehicle.

The engine ECU 8100, the ECT_ECU 8200, the TRC_ECU 8300, and the VSC_ECU 8400 are configured to enable mutual sending and receiving of signals. In this embodiment, a signal indicating the accelerator operation amount and a signal indicating the coolant temperature in the engine 1000 are sent to the ECT_ECU 8200 from the engine ECU 8100. A signal indicating the demanded torque amount established by the torque to be output from the engine 1000 is sent to the engine ECU 8100 from the ECT_ECU 8200. A signal indicating the torque demanded from the engine 1000 to achieve stable vehicle behavior is sent to the ECT_ECU 8200 from the TRC_ECU 8300 and the VSC_ECU 8400.

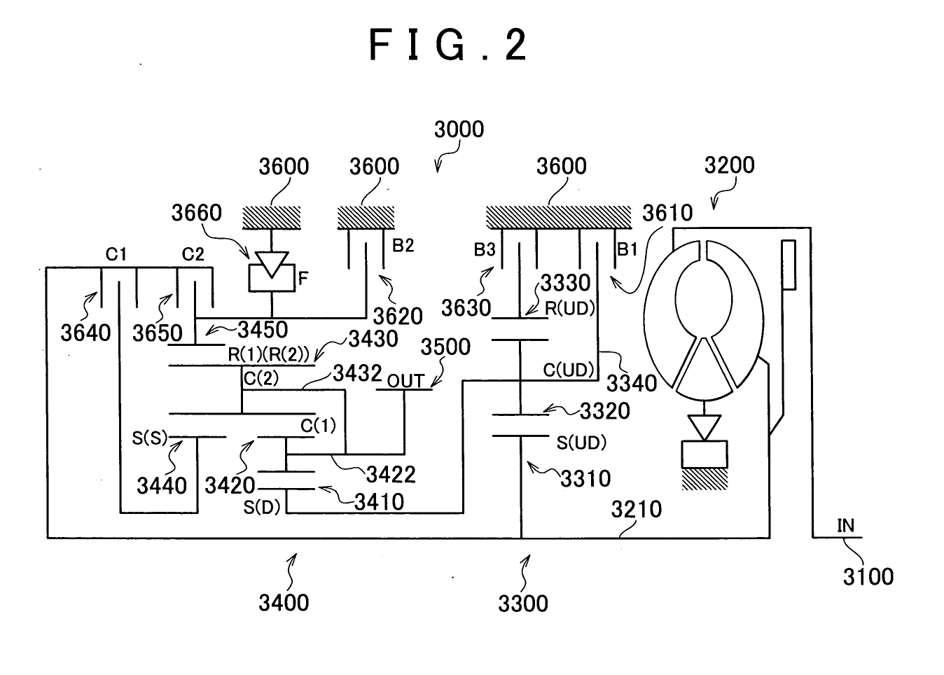

Referring to FIG. 2, the planetary gear unit 3000 will now be described. The planetary gear unit 3000 is connected to the torque converter 3200, which has an input shaft 3100 coupled to the crankshaft. The planetary gear unit 3000 includes a first set 3300 of the planetary gear mechanism, a second set 3400 of the planetary gear mechanism, an output gear 3500, and a B1 brake 3610, a B2 brake 3620, and a B3 brake 3630 connected the gear case 3600, a C1 clutch 3640, a C2 clutch 3650, and a one-way clutch F 3660.

The first set 3300 is a single-pinion type planetary gear mechanism. The first set 3300 includes a sun gear S (UD) 3310, a pinion gear 3320, a ring gear R (UD) 3330, and a carrier C (UD) 3340.

The sun gear S (UD) 3310 is coupled to the output shaft 3210 of the torque converter 3200. The pinion gear 3320 is supported by the carrier C (UD) 3340 to permit free rotation. The pinion gear 3320 meshes with the sun gear S (UD) 3310 and the ring gear R (UD) 3330.

The ring gear R (UD) 3330 is fixed to the gear case 3600 by the B3 brake 3630. The carrier C (UD) 3340 is fixed to the gear case 3600 by the B1 brake 3610.

The second set 3400 is a Ravigneaux-type planetary gear mechanism. The second set 3400 includes a sun gear S (D) 3410, a short pinion gear 3420, a carrier C (1) 3422, a long pinion gear 3430, a carrier C (2) 3432, a sun gear S (S) 3440, and ring gear R (1) (R (2)) 3450.

The sun gear S (D) 3410 is coupled to the carrier C (UD) 3340. The short pinion gear 3420 is supported by the carrier C (1) 3422 to permit free rotation. The short pinion gear 3420 meshes with the sun gear S (D) 3410 and the long pinion gear 3430. The carrier C (1) 3422 is coupled to the output gear 3500.

The long pinion gear 3430 is supported by the carrier C (2) 3432 to permit free rotation. The long pinion gear 3430 meshes with the short pinion gear 3420, the sun gear S (S) 3440, and the ring gear R (1) (R(2)) 3450. The carrier C (2) 3432 is coupled to the output gear 3500.

The sun gear S (S) 3440 is coupled to the output shaft 3210 of the torque converter 3200 by the C1 clutch 3640. The ring gear R(1) (R(2)) 3450 is fixed to the gear case 3600 by the B2 brake 3620, and is coupled to the output shaft 3210 of the torque converter 3200 by the C2 clutch 3650. The ring gear R(1) (R(2)) 3450 is coupled to the one-way clutch F 3660, and becomes unrotatable at the time of driving at the first gear step.

The one-way clutch F 3660 is provided in parallel with the B2 brake 3620. That is, the outer race of the one-way clutch F 3660 is fixed to the gear case 3600, and the inner race thereof is coupled via a rotating shaft to the ring gear R(1) (R(2)) 3450.

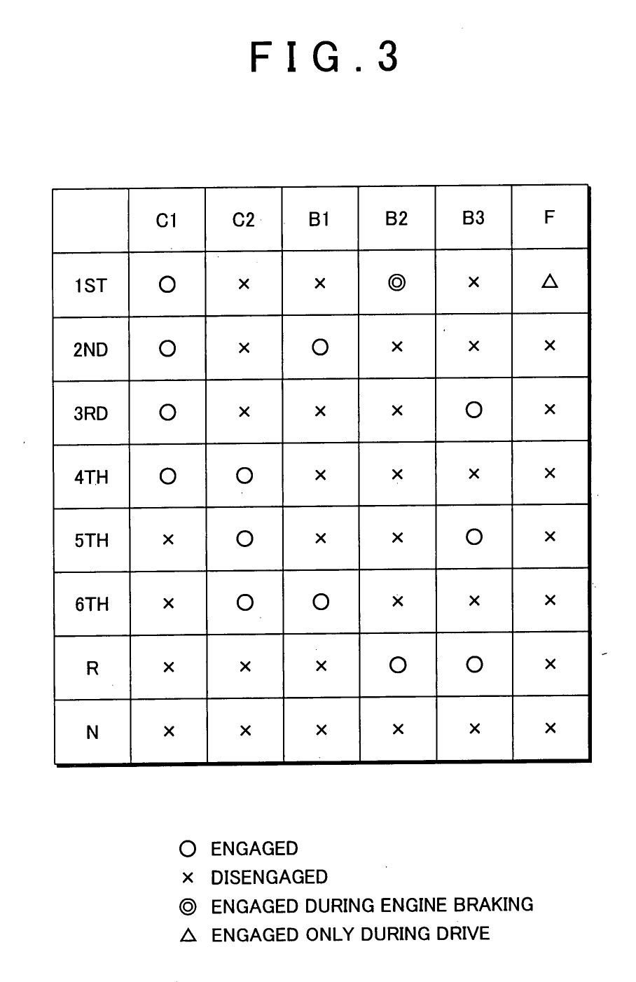

FIG. 3 shows an operation table indicating the relationship between each gear step and the operation conditions of each clutch and brake. The first to sixth forward gear steps and the reverse gear step are formed by operating the brakes and clutches in the combinations shown in the operation table.

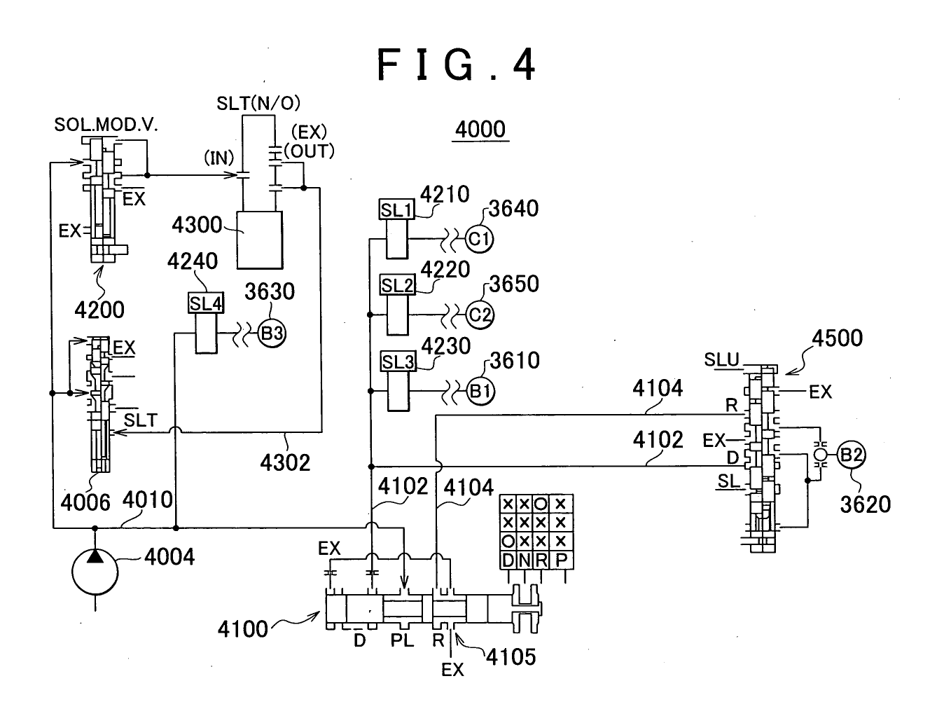

Referring to FIG. 4, the main parts fusion object the hydraulic circuit 4000 will now be described. The hydraulic circuit 4000 is not restricted to the following description.

The hydraulic circuit 4000 includes an oil pump 4004, a primary regulator valve 4006, a manual valve 4100, a solenoid modulator valve 4200, an SL1 linear solenoid (hereinafter referred to as SL(1)) 4210, an SL2 linear solenoid (hereinafter referred to as SL(2)) 4220, an SL3 linear solenoid (hereinafter referred to as SL(3)) 4230, an SL4 linear solenoid (hereinafter referred to as SL(4)) 4240, an SLT linear solenoid (hereinafter referred to as SLT) 4300, and a B2 control valve 4500.

The oil pump 4004 is coupled to the crankshaft of the engine 1000. The rotation of the crankshaft drives the oil pump 4004 and generates hydraulic pressure. The hydraulic pressure generated by the oil pump 4004 is adjusted by the primary regulator valve 4006, and line pressure is generated.

The primary regulator valve 4006 operates with the throttle pressure adjusted by the SLT 4300 as the pilot pressure. The line pressure is supplied to the manual valve 4100 via the line pressure oil passage 4010.

The manual valve 4100 includes a drain port 4105. The hydraulic pressure of the D range pressurized oil path 4102 or the R range pressurized oil path 4104 is discharged from the drain port. If the spool of the manual valve 4100 is in the D position, the line pressure oil path 4010 and the D range pressurized oil path 4102 are caused to communicate, so that hydraulic pressure is supplied to the D range pressurized oil path 4102. When this occurs, the R range pressurized oil path 4104 and the drain port 4105 are caused to communicate, so that the R range pressure of the R range pressurized oil path 4104 is discharged from the drain port.

If the spool of the manual valve 4100 is in the R position, the line pressure oil path 4010 and the R range pressurized oil path 4104 are caused to communicate, so that hydraulic pressure is supplied to the R range oil path 4104. When this occurs, the D range pressure oil path 4102 and the drain port 4105 are caused to communicate, so that the D range pressure of the D range pressurized oil path 4102 is discharged from the drain port 4105.

If the spool of the manual valve 4100 is in the N position, both the D range pressurized oil path 4102 and the R range pressurized oil path 4104 are caused to communicate with the drain port 4105, so that the D range pressure of the D range pressurized oil path 4102 and the R range pressure of the R range pressurized oil path 4104 are discharged from the drain port 4105.

The hydraulic pressure supplied to the D range pressurized oil path 4102 ultimately is supplied to the B1 brake 3610, the B2 brake 3620, the C1 clutch 3640, and the C2 clutch 3650. The hydraulic pressure supplied to the R range pressurized oil path 4104 is ultimately supplied to the B2 brake 3620.

The solenoid modulator valve 4200, taking the line pressure as the base pressure, adjusts the hydraulic pressure (solenoid modulator pressure) supplied to the SLT 4300 to a constant pressure.

The SL (1) 4210 adjusts the hydraulic pressure supplied to the C1 clutch 3640. The SL (2) 4220 adjusts the hydraulic pressure supplied to the C2 clutch 3650. The SL (3) 4230 adjusts the hydraulic pressure supplied to the B1 brake 3610. The SL (4) 4240 adjusts the hydraulic pressure supplied to the B3 brake 3630.

In response to a control signal from the ECU 8000 based on the accelerator operation amount detected by the accelerator operation amount sensor 8010, the SLT 4300 adjusts the solenoid modulator pressure and generates the throttle pressure. The throttle pressure is supplied to the primary regulator valve 4006 via the SLT oil path 4302. The throttle pressure is used as the pilot pressure for the primary regulator valve 4006.

The SL (1) 4210, the SL (2) 4220, the SL (3) 4230, the SL (4) 4240, and the SLT 4300 are controlled by control signals send from the ECU 8000.

The B2 control valve 4500 selectively supplies one of the hydraulic pressure from one of the D range pressurized oil path 4102 and the R range pressurized oil path 4104 to the B2 brake 3620. The R range pressurized oil path 4102 and the R range pressurized oil path 4104 are connected to the B2 control valve 4500. The B2 control valve 4500 is controlled by hydraulic pressure supplied from an SL solenoid valve (not illustrated) and the SLU solenoid valve (not illustrated), and by the impelling force of a spring.

With the SL solenoid valve off and the SLU solenoid valve on, the B2 control valve 4500 is in the left side condition shown in FIG. 4. In this case, the hydraulic pressure of the D range pressure, adjusted with the hydraulic pressure supplied from the SLU solenoid valve as the pilot pressure, is supplied to the B2 brake 3620.

With the SL solenoid valve on and the SLU solenoid valve off, the B2 control valve 4500 is in the right side condition shown in FIG. 4. In this case, the R range pressure is supplied to the B2 brake 3620.

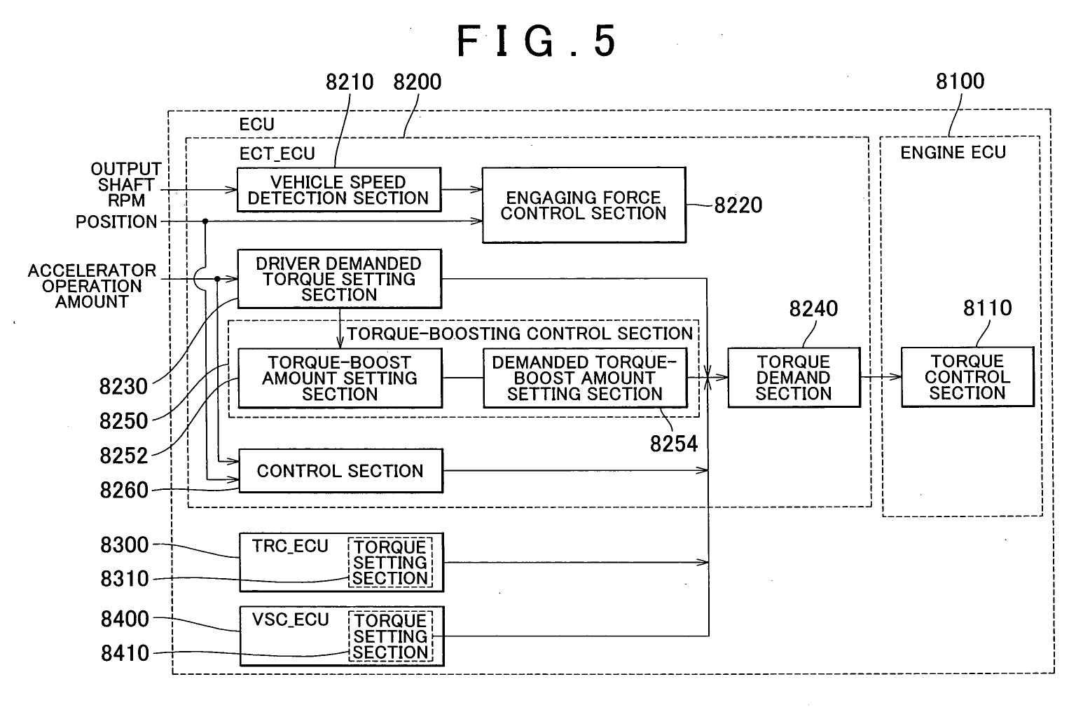

Referring to FIG. 5, the ECU 8000 will be further described below. The functionality of the ECU 8000 described below may be implemented with hardware or alternatively may be implemented with software.

The engine ECU 8100 of the ECU 8000 includes a torque control section 8110. The torque control section 8110, upon receiving a demanded torque amount output from the ECT_ECU 8200, controls the degree of throttle opening of the electronic throttle valve 8016 and the ignition timing of the ignition plugs to output a torque corresponding to the demanded torque amount.

The ECT_ECU 8200 of the ECU 8000 includes a vehicle speed detection section 8210, an engaging force control section 8220, a driver demanded torque-setting section 8230, a torque demand section 8240, a torque-boost control section 8250, and a limiting section 8260.

The vehicle speed detection section 8210 calculates (detects) the vehicle speed from the output shaft rotational speed NO of the automatic transmission 2000. During and after completion of a gear shift the engaging force control section 8220 controls the engaging force of the B1 brake 3610, the B2 brake 3620, the B3 brake 3630, the C1 clutch 3640, and the C2 clutch 3650.

The driver demanded torque amount setting section 8230, based on the accelerator operation amount and the like, sets the driver demanded torque, which is the torque demanded by the driver. The driver demanded torque is set in response to the accelerator operation amount, so that it is greater the greater is the accelerator operation amount.

The torque demand section 8240 sets the demanded torque amount based on the driver demanded torque and the like, which is the torque demanded from the engine 1000. In steady-state running and the like, in which gear shifting is not done, the driver demanded torque is set as the demanded torque amount.

The torque boost control section 8250 executes the torque-boost control to increase the torque during the torque phase when up-shifting. The torque-boost control section 8250 includes a torque-boost setting section 8252 and a demanded torque-boost amount setting section 8254.

The torque boost setting section 8252 sets the amount of torque boost demanded from the engine 1000 in performing the torque-boost control. The torque-boost amount is set in response to the driver demanded torque, that is, to the accelerator operation amount.

The demanded torque-boost amount setting section 8254, during the torque phase when up-shifting, sets the demanded torque amount to increase to the torque-boosted amount pre-established in this embodiment. That is, the value that the demanded torque amount finally reaches is the torque-boosting amount.

When executing the torque-boost control, the torque demand section 8240 sets the demanded torque amount as the torque obtained by adding the demanded torque-boost amount to the demanded torque amount. That is, in performing the torque-boost control, torque-boosting is performed using the demanded drive torque as the reference.

When the shift lever 8004 is changed from the N (neutral) position to the D (drive) position, if the driver depresses the accelerator, the control section 8260 sets a torque that is different from the driver demanded torque that is set in response to the accelerator operation amount to control the torque output from the engine 1000.

In this embodiment the control section 8260 sets a smaller torque than the driver demanded torque. The torque set by the control section 8260 takes precedence over the driver demanded torque. That is, by the control section 8260 setting the torque, the torque output from the engine 1000 is automatically controlled, independently of the accelerator operation amount.

The TRC_ECU 8300 includes a torque setting section 8310. When the vehicle is starting or accelerating, if wheel slip is detected, the torque setting section 8310 of the TRC_ECU 8300 sets a torque that is different from the driver demanded torque, to stabilize the vehicle behavior. The torque setting section 8310 of the TRC_ECU 8300 sends a signal to the ECT_ECU 8200 indicating the torque to be set.

In this case, the torque section 8240 of the ECT_ECU 8200 sets the torque set by the torque setting section of the TRC_ECU 8300 as the demanded torque amount. That is, by the torque setting section 8310 of the TRC_ECU 8300 setting the torque, the torque output from the engine 1000 is automatically controlled, without dependence on the accelerator operation amount. Because known art can be used as a method for detecting wheel slipping, the details thereof will not be described herein.

The VSC_ECU 8400 includes a torque setting section 8410. When the vehicle is turning or the like, if skidding of the vehicle is detected, the torque setting section 8410 of the VSC_ECU 8400 sets a torque that is different from the driver demanded torque to stabilize the vehicle. A signal indicating the torque set by the torque setting section 8410 of the VSC_ECU 8400 is sent to the ECT_ECU 8200.

1 In this case, the torque demand section 8240 of the ECT_ECU 8200 sets the torque set by the torque setting section 8410 of the VSC_ECU 8400 as the demanded torque amount. That is, by the torque setting section 8410 setting the torque, the torque output from the engine 1000 is automatically controlled independently of the accelerator operation amount. Because known art can be used as a method for detecting skidding of the vehicle, the details thereof will not be described herein.

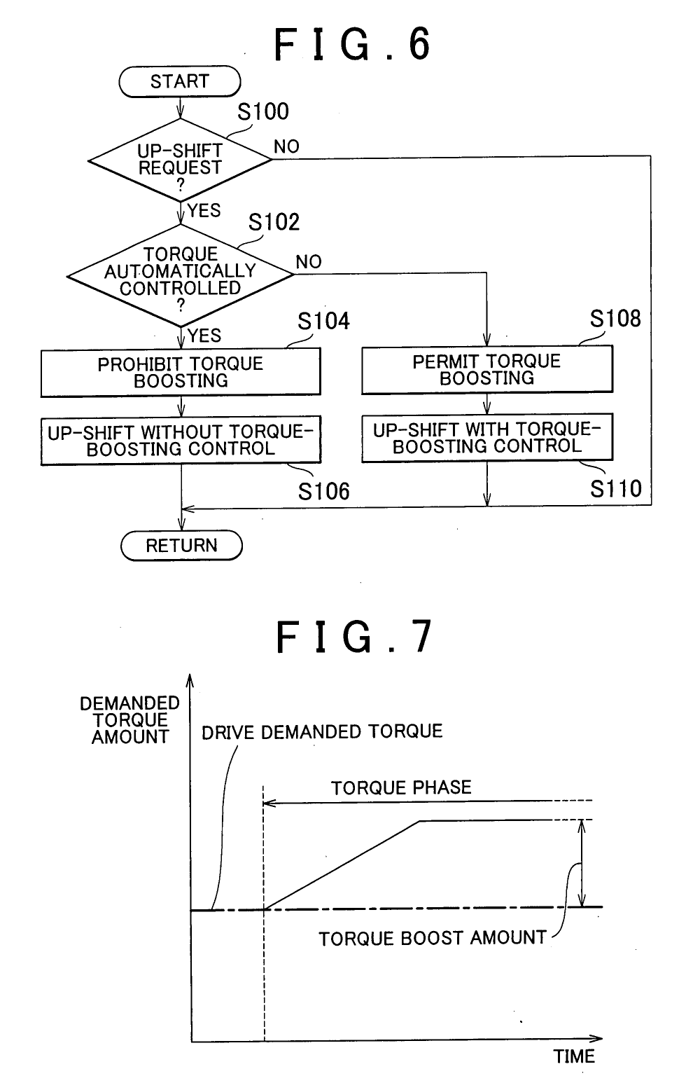

Referring to FIG. 6, the control structure of the program executed by the ECU 8000, which functions as the controller according to this embodiment, will be described next. The program described below is repeatedly executed at a pre-established intervals. Program steps will be indicated in abbreviated form, such as S100 for step 100.

At step S100, the ECU 8000 determines whether or not there is an up-shift request. Whether or not there is an up-shift request is determined based on the gear shift graph. If there is an up-shift request (YES at S100), processing proceeds to S102, and if not (NO at S100), processing ends.

At S102, the ECU 8000 determines whether the torque output from the engine 1000 is being automatically controlled independently of the accelerator operation amount. That is, it is determined whether at least one of the control section 8260 of the ECT_ECU 8200, the TRC_ECU 8300, and the VSC_ECU 8400 is setting the torque. If the torque is under automatic control (YES at S102), processing proceeds to S104, and if not (NO at S102), processing proceeds to S108.

At S104, the ECU 8000 prohibits the torque-boost control. At S106, the ECU 8000 boosts the torque without performing the torque-boost control during the torque phase, and makes an up-shift.

At S108, the ECU 8000 permits torque-boosting control. At S110, the ECU 8000 performs the torque-boost control and boosts the torque during the torque phase, and makes an up-shift.

The operation of the ECU 8000, which functions as the controller according to this embodiment, is described below, based on the foregoing structure and flowchart.

When the vehicle is moving, and an up-shift request occurs (YES at S100), a determination is made as to whether or not the torque output from the engine 1000 is being automatically controlled independently of the accelerator operation amount (S102).

If the torque output from the engine 1000 is not being automatically controlled (NO at S102), the torque-boost control is permitted (S108). For this reason, as shown by the solid line in FIG. 7, the torque-boost control is performed during the torque phase, and an up-shift is made (S110).

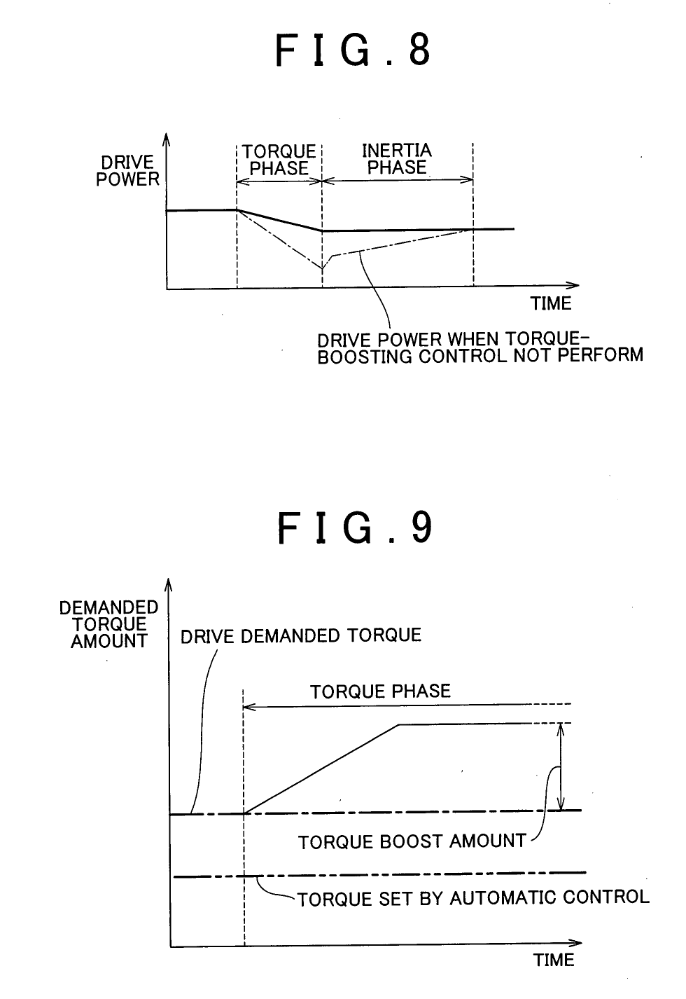

By doing this, as shown by the solid line in FIG. 8, it is possible to suppress a decrease in the drive power during the torque phase. For this reason, it is possible to suppress an increase in the drive power when transitioning from the torque phase to the inertia phase. As a result, it is possible to suppress a shock at the time of gear shifting.

If the torque output from the engine 1000 is being automatically controlled independently of the accelerator operation amount (YES at S102), as shown by the double-dot-dashed line in FIG. 9, before the start of the torque phase there are cases in which automatic control sets a torque that is smaller than the driver demanded torque.

In such a condition, if the torque-boost control establishes a demanded torque amount based on the driver demanded torque as a reference, the demanded torque amount changes suddenly from the torque set by automatic control to the driver demanded torque. In this case, there is a sudden increase in the torque output from the engine 1000 and a shock is generated.

In this case, when torque output from the engine 1000 is being automatically controlled (YES at S102), torque-boosting control is prohibited during the torque phase (S104). Up-shifting, therefore, is done without performing the torque-boost control during the torque phase. By doing this, it is possible to suppress sudden changes in the torque output from the engine 1000. For this reason, it is possible to suppress the occurrence of a shock when changing gears.

In an embodiment of the present invention as described above, when an up-shift request occurs if the torque output from the engine is automatically controlled independently of the accelerator operation amount, the torque-boost control is prohibited during the torque phase. By doing this, it is possible to suppress sudden changes from the torque set by automatic control to the driver demanded torque established in response to the accelerator operation amount. For this reason, it is possible to suppress sudden changes in the torque output from the engine, and as a result it is possible to suppress a shock when shifting gears.

Although in this embodiment of the present invention, automatic control of the torque is performed by at least one of the control section 8260 of the ECT_ECU 8200, the TRC_ECU 8300, and the VSC_ECU 8400, the constitution that performs automatic torque control is not restricted in this manner.

While the invention has been described with reference to what are considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, fewer, or only a single element, are also within the spirit and scope of the invention.

What is claimed is:

1. A vehicle controller for a vehicle equipped with a power source and an automatic transmission, connected to the power source, that establishes a plurality of gear steps having different gear ratios by selectively engaging a plurality of friction engaging elements comprising:
a torque booster that increases the torque of the power source during a torque phase of an up-shift when the automatic transmission is up-shifted, and
a device that prohibits increases of the torque during the torque phase when the torque of the power source is automatically controlled independently of an output amount demanded by a driver.

2. The controller of a vehicle according to claim 1, further comprising
an output controller that controls the power source in order to increase the torque based on a torque in response to the demanded output amount when increasing the torque during the torque phase.

3. The controller of a vehicle according to claim 1, wherein
the demanded output amount is based on an accelerator operation amount.

4. The controller of a vehicle according to claim 1, wherein
the torque of the power source is automatically controlled when a shift lever is operated from a position not intended for moving a vehicle to a position intended for moving a vehicle.

5. The controller of a vehicle according to claim 1, wherein
the torque of the power source is automatically controlled when wheel slip is detected when the vehicle is starting or accelerating.

6. The controller of a vehicle according to claim 1, wherein
the torque of the power source is automatically controlled when a skidding of vehicle is detected.

7. A method of controlling a vehicle equipped with a power source and an automatic transmission, connected to the power source, that establishes a plurality of gear steps with different gear ratios by selectively engaging a plurality of friction engaging elements, the method comprising:
increasing the torque of the power source during a torque phase of an up-shift when the automatic transmission is up-shifted, and
prohibiting increases in the torque during the torque phase when the torque of the power source is automatically controlled independently of an output amount demanded by a driver.
